(19) United States
(12) Patent Application Publication
(10) Pub. No.: US 2007/0092628 A1
(43) Pub. Date: Apr. 26, 2007

(54) Aseptic liquid non dairy creamer

(76) Inventors: Taiben Cheng, Chesterfield, VA (US); Susan Franz, Arlington Heights, IL (US)

Correspondence Address: HODGSON RUSS LLP, ONE M & T PLAZA, SUITE 2000, BUFFALO, NY, 14203-2391, US

(21) Appl. No.: 11/546,070

(22) Filed: Oct. 11, 2006

Related U.S. Application Data
(60) Provisional application No. 60/725,408, filed on Oct. 11, 2005.

(51) Int. Cl. A23D 9/00

(52) U.S. Cl. 426/601

(57) ABSTRACT

Provided are compositions for a pourable creamer suitable for aspetic packaging comprising fat, emulsifiers, non-reducing sugars, and gums. The aspectically packaged creamer can be stably stored at ambient temperature for at least 6 months and at referigerated temperatures for at least 1 year.

This application claims priority to U.S. Provisional application No. 60/725,408 filed on Oct. 11, 2005, the disclosure of which is incorporated herein by reference.

### FIELD OF THE INVENTION

This invention relates generally to the field of hot beverage creamers and more particularly to an aseptic non-dairy creamer which has improved mouth feel and storage properties.

### DESCRIPTION OF RELATED ART

Creamers are often used with hot beverages like coffee and tea. Fresh or refrigerated dairy products generally provide desirable taste but have the disadvantage that these need to be obtained fresh and therefore frequently. Further, these products do not have long storage capability.

Non-dairy creamers provide a substitute for the dairy creamers. The non-dairy creamers are generally made of vegetable or animal fats, carbohydrates, protein, emulsifiers, and stabilizing and buffering salts. The powdered forms of the non-dairy creamers do not adequately simulate the taste or mouth feel of the dairy creamers. The liquid emulsion non-dairy creamers more closely stimulate the dairy creamers than the powdered creamers. However, the liquid non-dairy creamers do not have a long shelf life.

U.S. Pat. No. 4,748,028 to McKenna describes aseptic coffee creamers. The only examples presented are for 10.5% fat. This is the typical fat content of half-and-half and does not have the same mouthfeel as the typical 18% coffee creamers. The '028 patent describes the emulsion content to be between 0.07 to 0.3% and indicates that the emulsifiers should not be above 1%.

Therefore, there is a need in the hot beverage industry for a non-dairy creamer which has a long shelf storage life and yet provides a taste and mouth-feel similar to a dairy creamer.

### SUMMARY OF THE INVENTION

The present invention provides a pourable liquid creamer suitable for aseptic packaging comprising 12-15% fat; 3-6% non-reducing sugars; 1 to 4% emulsifiers and between 0.02 to 0.2% gums. Once aseptically packaged, the creamer can be stored for at least 6 months at room temperature and for at least 1 year at refrigerated temperature. Additionally, the creamer can also be frozen and thawed without losing emulsion stability.

In one embodiment, the fat content of the creamer is about 14%. The creamer of this embodiment has the mouthfeel similar to that of an 18% fat creamer and the stability characteristics similar to that of a typical half-and-half creamer which has less than 11% fat.

During the preparation of the aseptic creamer, the composition can be subjected to direct UHT treatment. The combination of emulsifiers, gums, fat and the ability to subject the composition to direct UHT treatment is believed to contribute at least in part to the desirable taste characteristics and the improved shelf stability.

### BRIEF DESCRIPTION OF THE DRAWINGS

FIGS. 1A to 1F shows the particle size distribution for compositions of the present invention comprising 3.5% emulsifiers (A); 1.75% emulsifiers (B); 1.25% emulsifiers (C); 0.75% emulsifiers (D); 0.3% emulsifiers (E) and 0.07% emulsifiers (F).

### DETAILED DESCRIPTION OF THE INVENTION

The present invention provides a pourable liquid non-dairy creamer. The non-dairy creamer product comprises non dairy fats, sweeteners, emulsifier system and gum (hydrocolloid) system. The combination and level of non dairy fat, sugar content, emulsifier mixture and gum stabilizer system makes this product a stable emulsion system at ambient temperature as well as refrigerated temperature (from 4° C. to 25° C.).

Non dairy fat includes palm oil, palm kernel oil, corn oil, coconut oil, soybean oil, peanut oil, cottonseed oil, or stearine fractions thereof or blends of any vegetable oils mentioned above. Fats with a melt point around mouth temperature (32-42)° C. are preferable. The fat level in the creamer is between 12 to 15% and in a preferred embodiment, the fat level is about 14%. With the right level and combination of emulsifiers and gums, the creamer with a 14% fat content has the mouth-feel of a typical 18% fat dairy creamer and exhibits stability at ambient temperature.

Aqueous sweetener solution is made of liquid sucrose or granular sucrose. In the present invention, it is preferred that non-reducing sugars be used because non-reducing sugars prevent the browning reaction and therefore help to maintain a desirable appearance of the product over the storage/use period. While not intending to be bound by any particular theory, it is considered that non-reducing sugars prevent the creamer from becoming darker by preventing reaction with protein materials. Therefore in one embodiment Sucrose can be used as the non reducing sugar. Further, the use of non-reducing sugar such as sucrose helps lactose intolerance individual to consumer this creamer. The sucrose level in the creamer is between 3 to 6%, and in the preferred embodiment, the sucrose content is about 4%. In another embodiment, another non-reducing sugar, Trehalose, or combinations of non-reducing sugars can be used.

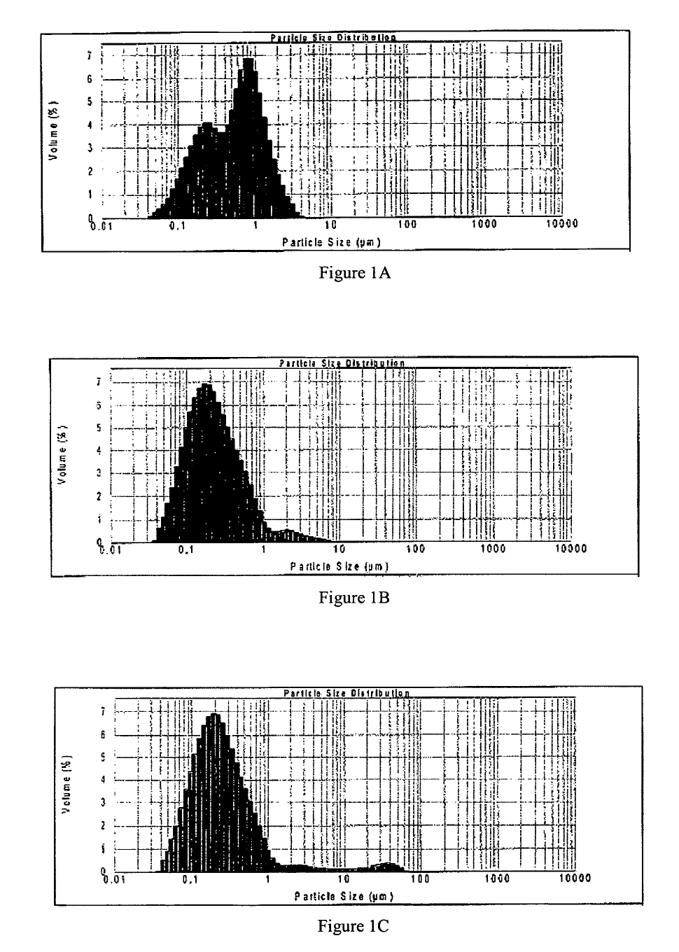

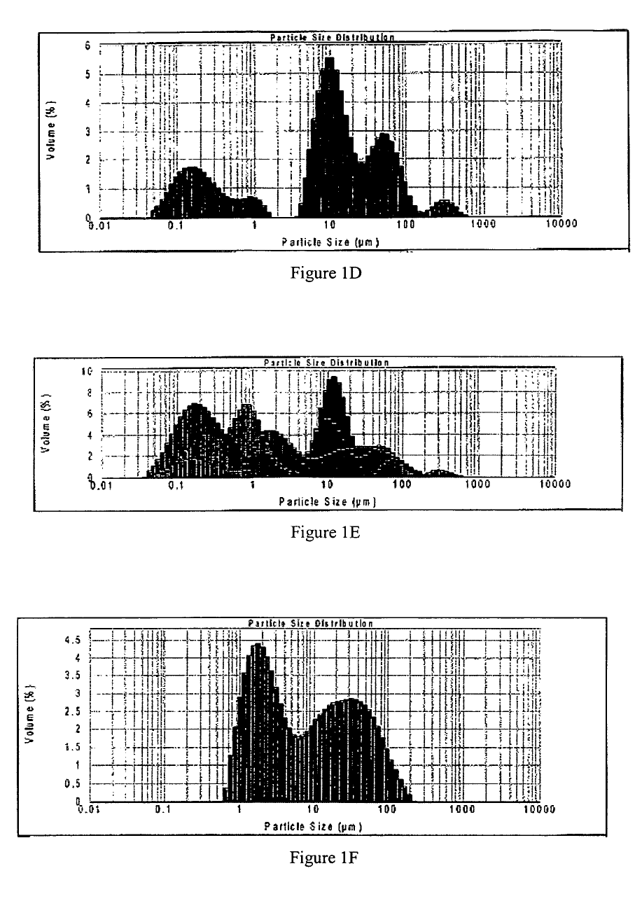

Emulsifier agents used in creamer are polar lipids. Polar lipid includes sorbitan tristerate, propylene glycol esters, lactic acid esters, mono di-glyceride, lecithin, sorbitan monosterate, diacetyl tartaric acid esters of mono-diglycerides (DATEM), citric acid esters, polysorbate 60, sodium steroyl lactylate etc. During homogenization at high temperature, polar lipids take part in emulsification process of oil and water. They help to reduce interfacial tension for oil in water emulsion. For the selection of polar lipid in creamer application, a mixture of hydrophilic and lipophilic emulsifiers is generally considered having best while in combining with sodium caseinate. Commonly used lipophilic emulsifiers are polysorbate 60, sodium steroyl lactylate, DATEM, or citric acid ester. Commonly used hydrophilic emulsifiers are mono, mono-diglyceride, and lecithin. The particular combination of emulsifier mixture with phosphate salts provides stable oil in water emulsion system at ambient and refrigerated storage temperature. For the present invention it was observed that the emulsifier level should be at least 1%. The preferable emulsifier concentration is between 1 to 4%. In one embodiment, the emulsifier level is between 1 to 3% and in another it is between 1 to 2%. Some specific examples of emulsifier concentrations are 1.25%, 1.5%, 1.75%, 2.0% and 2.25%. When particle size distributions for the various emulsifier concentrations were studied, it was observed that emulsifier concentrations above 1% resulted in better stability. For example, the particle size range for 1.25% and 1.75% emulsifiers was from 0.05 to 1.0 microns (for about 90 to 95% of the particles). Thus, with both 1.25% and 1.75% emulsifiers, the particle size distributions indicated the emulsion has good stability. The composition with 3.5% emulsifiers also had a narrow particle size range although the average particle size was slightly larger (0.08 to 2.5 microns for about 95% of the particles). When lower levels of emulsifiers were used, the cream tended to lose emulsion stability. This was supported by the particle size distributions seen for the lower emulsifier concentrations. For example, it was observed that 0.07% emulsifiers and 0.3% emulsifiers produced a large range in size from about 1 to 100 microns (for about 95% of the particles). Additionally, the 0.3% emulsifier composition had several cluster areas. A composition with 0.75% emulsifiers also showed a distribution from 0.1-200 microns. The inconsistent particle sizes and the tendency toward larger particle size both indicate emulsion instability for emulsifier concentrations less than 1%. The particle size distributions for various emulsifier concentrations are shown in FIGS. 1A-1F. The emulsifiers used for calculating the concentrations were DATEM, mono di-glyceride and polysorbate 60. Therefore, it is preferable to use emulsifier concentration of 1% or higher. Accordingly, in one embodiment, the creamer of the invention comprises emulsion particles in which at least 70% of the particles have a particle size of between 0.05 to 1 micron. In other embodiments, the percentage of particles having a particle size between 0.05 to 1 micron is at least 80%, at least 85%, at least 90%, and at least 95%. In further embodiment, at least 80, 85, 90, or 95% of the particles have a particle size between 0.05 to 2, 3 4 or 5 microns.

The gum or hydrocolloid system is one of key components for stabilize the oil in water emulsion. The gum system includes gum Arabic, Xantham gum, carboxymethyl cellulose, hydroxypropyl cellulose, methyl cellulose, microcrystalline cellulose, agar, alginates, carrageenan, pectin, gelatin etc. By identifying the right combination of gums, this emulsion system stays stable for at least 6 months at ambient temperature and at least one year at refrigerated temperatures. In one embodiment, the gum system comprises carrageenan and carboxymethylcellulose. The gum level is between 0.02 to 0.2%. In a preferred embodiment, the range is between 0.05 to 0.1%.

The creamer of the present invention also contains proteins. Protein materials may form a protective coating around the oil droplet and prevent them form coalescing with each other. The protein may be the milk protein casein. The casein may be in the form of calcium caseinate, sodium caseinate potassium caseinate or the like. The protein is present in the range of 0.5 to 3%. In one embodiment, the protein is between 0.75 to 2%. In another embodiment, it is about 1%.

To enhance the appearance and flavor of this product, flavor and color additive can be used. For example, a natural rosemary extract solution, or milk flavor can be added to maintain the stability of fat component in the formula.

Other ingredients such as water, buffer salts etc. are also added and are known to those skilled in the art.

This product is a shelf stable non dairy coffee creamer. It is a microbial stable and emulsion stable product at ambient or refrigerated temperature. This product is user friendly for individuals who cannot digest the lactose in the dairy cream, to enjoy coffee/tea with cream flavor. Additionally, it was also observed that in contrast to the products described in the prior art and currently commercially available, the present product can be frozen and thawed without losing its emulsion stability. This property provides an additional advantage whereby more flexible shipping arrangements can be used by manufacturers. It is preferred that for the product be frozen at a rate that it reaches the frozen state within 12 hours.

For preparation of the creamer, it is preferable to make the aqueous phase and the premix separately. The aqueous phase is heated and kept at a temperature such that the gums are fully hydrated. A suitable temperature is at least 60° C., preferably at least 70° C., but preferably below 80° C. The premix is then added to the aqueous phase. The fat component is then added and also any additives such as flavoring agents, coloring agents can be added.

The composition is then heated by direct heating. The particular combination of fat, protein, non-reducing sugar, emulsifiers and gums makes the present composition amenable to direct heating. It is believed that the direct UHT treatment is at least in part, responsible for the improved stability of the emulsions. Accordingly, the creamer composition is heated by processing through a steam infusion system such that the product is heated to 144° C. preferably for at least 3.6 seconds. Those skilled in the art will recognize that in a batching process, this is the average time calculated based on the time a certain volume of the product takes to pass through the steam infusion system. The heat treatment UHT process ensures a product to be commercially sterilized.

The product is then homogenized as follows. The heated creamer liquid is passed through a homogenizer with a pressure from 1500 to 7000 psi for 1^{st} stage and from 400 to 600 psi for the 2^{nd} stage. The preferred embodiment is from 3500 to 5000 psi for 1^{st} stage and 500 psi for the 2^{nd} stage. The non dairy fat is broken down to very small particle with an average size of 0.3 to 0.6 micrometer.

The aseptically packaged coffee creamer can be stored at ambient temperature or at refrigerated temperatures. As described above, the coffee creamer can also be frozen and thawed without losing emulsion stability.

The coffee creamer of the present invention can be used not only for coffee, but also for whitening or addition to other hot or cold drinks/food such as tea, cocoa, soup, cereal and the like. It may also be used in cooking applications such as in place of dairy cream.

### EXAMPLE 1

This example provides one illustration of the formulation. This formulation contained 14% fat. The premix was made as follows:

| Premix description | % |
|---|---|
| Sugar | 17.2 |
| carrageenan | 0.6 |
| carboxymethylcellulose | 1.5 |
| mono diglyceride 40% | 10.8 |
| Oil canola solo 1000 | 0.5 |
| Dipotassium phosphate | 25 |
| sodium caseinate | 27.9 |
| DATEM | 16.5 |
| Total | 100 |

The premix was added to the other components in the formula as follows:

| Ingredient | Percent |
|---|---|
| Palm kernel oil | 14.2 |
| premix | 3.6 |
| polysorbate 60 | 0.3 |
| Water | 77.6 |
| sugar | 4.3 |
| Total | 100.0 |

The formulation also contained less than 0.1% of dairy flavor; antifoam powdered 1920, beta carotene 30%, and rosemary extract.

This formulation formed a creamer which had a desirable mouth feel and taste. It was stable for at least 6 months at room temperature and for 1 year at refrigerated temperature.

### EXAMPLE 2 (COMPARATIVE)

In this example, formulations containing 18% fat were prepared as follows. These two non-dairy creamer samples are designated for the purposes of this example as RPC 11 and RPC12.

Non dairy creamer

| | RPC 11 | RPC 12 |
|---|---|---|
| Ingredient | % | % |
| palm kernel oil | 18.0 | 18.0 |
| condensed milk flavor | 0.01 | 0.03 |
| sodium stearoyl lactylate | 0.3 | 0.3 |
| antifoam powder | 0.015 | 0.015 |
| Carrageenan | 0.04 | 0.04 |
| premix | 1.50 | 1.5 |
| polysorbate 60 | 0.3 | 0.3 |
| Water | 74.83 | 74.81 |
| sugar solution | 5.0 | 5.0 |
| Total | 100.0 | 100.0 |

| premix description | % |
|---|---|
| Sugar | 71.18 |
| Carrageenan | 2.3 |
| Carboxymethylcellulose | 6 |
| sodium stearoyl lactylate | 10 |
| mono diglyceride 40% | 10 |
| oil canola solo 1000 | 0.52 |
| Total | 100 |

The formulation also contained rosemary extract and beta carotene. One hundred volunteer consumers were identified as coffee drinkers and recruited for tasting the creamers. The consumers were screened for dairy allergy. The tasters were asked to answer questions relating to: liking the color of the creamer; liking the overall appearance of the coffee; liking the aroma of the coffee; liking the dairy flavor of the coffee; rating the intensity of dairy flavor of the coffee; liking the coffee flavor; rating the intensity of coffee flavor; liking the mouth-feel; liking aftertaste; and the overall liking.

While the formulations with 18% fat were generally liked, the emulsion at this fat content could not be stabilized and had a tendency of gelling at room temperature. Therefore, this formulation is not suitable for a pourable liquid creamer with shelf stability for the present invention.

### EXAMPLE 3

In this example, sensory testing was done to compare formulations comprising 14% fat (Example 1) versus 18% fat (Example 2) as coffee creamers. For the testing, 47 in-house volunteers were used. Respondents were given samples of 14% cream and 18% cream. The samples were blind coded and were tasted one at a time. A ranking scale of 1-9 for key attributes was used—1 meaning none and 9 meaning extremely. The results indicated that the 14% formulation was significantly preferred over the 18% formulation in terms of mouthfeel, flavor, aftertaste, and overall liking. There was insignificant difference in the whitening power between the two formulations.

### EXAMPLE 4 (COMPARATIVE)

The critical role of combination selected emulsifier system and gum in stabilizing the oil in water emulsion system is further demonstrated in following example. This example provides formulations containing 18% fat in which the emulsion system failed in less than one week at ambient temperature 25° C.

Non dairy creamer

| | RPC 6 | RPC 7 |
|---|---|---|
| Ingredient | % | % |
| palm kernel oil | 18 | 18 |
| condensed milk flavor | 0.03 | 0.03 |
| emplex (sodium stearoyl lact) | 0.3 | 0.3 |
| Carrageenan | 0.02 | 0.04 |
| premix formula | 1.5 | 1.5 |
| polysorbate 60 | 0.3 | 0.3 |
| Water | 74.8 | 74.8 |
| HFCS | 5 | 5 |
| herbalox | 0.005 | 0.005 |
| 1% delta decalactone in triacetin | 0.01 | 0.007 |
| Total | 100 | 100 |

1. An aspectically packaged, liquid non-dairy creamer comprising about 12 to 15% fat, about 1 to 4% emulsifiers, about 3 to 6% non-reducing sugars; about 0.02 to 0.2% gums, wherein the creamer can be stored at ambient temperature for at least 6 months, at referigerated temperature for at least one year or can be frozen.

2. The creamer of claim 1, wherein the fat is about 14%.

3. The creamer of claim 2, wherein the fat is selected from the group consisting of palm oil, palm kernel oil, corn oil, coconut oil, soybean oil, peanut oil, cottonseed oil, stearine fractions thereof and blends thereof.

4. The creamer of claim 3, wherein the fat is palm kernel oil.

5. The creamer of claim 1, wherein the emulsifier component is about 1 to 3%.

6. The creamer of claim 1, wherein the emulsifiers component is about 1.25%, 1.5%, 1.75%, 2.0%, 2.25%, 2.25%, 2.5% or 2.75%.

7. The creamer of claim 6, wherein the emulsifier component is 1.25%.

8. The creamer of claim 1, wherein the emulsifier component comprises mono-diglyceride, DATEM and polysorbate 60.

9. The creamer of claim 1 wherein the gum component is about 0.05 and 0.1%.

10. The creamer of claim 1, wherein the gum component comprises carrageenan and carboxymethylcellulose.

11. The creamer of claim 1, wherein the non-reducing sugar is about 4%.

12. The creamer of claim 11, wherein the non-reducing sugar is sucrose.

13. The creamer of claim 1, further comprising about 1% milk protein.

14. The creamer of claim 1, wherein the fat component is palm kernel oil at about 14%, the emulsifier component comprises mono-diglyceride, DATEM and polysorbate 60 at 1.25%.

15. The creamer of claim 1 further comprising disodium phosphate.

16. A liquid non-dairy creamer comprising about 12 to 15% fat, about 1 to 4% emulsifiers, about 3 to 6% non-reducing sugars; about 0.02 to 0.2% gums, wherein the creamer comprises emulsion particles and wherein the particle size of at least 70% of the particles is between 0.05 to 1 micron.

17. The creamer of claim 16, wherein the particle size of at least 80% of the particles is between 0.05 to 1 micron.

18. The creamer of claim 17, wherein the particle size of at least 90% of the particles is between 0.05 to 1 micron.

19. The creamer of claim 18, wherein the particle size of at least 95% of the particles is between 0.05 to 1 micron.

20. The creamer of claim 16, which can be stored at ambient temperature for at least 6 months, at referigerated temperature for at least one year when aspectically packaged.
